(19) United States
(12) Patent Application Publication
(10) Pub. No.: US 2025/0233296 A1
(43) Pub. Date: Jul. 17, 2025

(54) RADIOFREQUENCY GENERATOR ARRANGEMENT WITH A PLUG-IN CONNECTION INTEGRATED IN A COMBINER

(71) Applicant: TRUMPF Huettinger GmbH + Co. KG, Freiburg (DE)

(72) Inventor: Johannes Schlundt, Karlsruhe (DE)

(21) Appl. No.: 18/942,805

(22) Filed: Nov. 11, 2024

Related U.S. Application Data
(63) Continuation of application No. PCT/EP2023/062201, filed on May 9, 2023.

(30) Foreign Application Priority Data
May 12, 2022 (DE) 10 2022 111 955.6

(51) Int. Cl. H01P 5/18; H01R 24/40; H05H 7/02; H05H 9/00

(52) U.S. Cl. CPC H01P 5/183; H01R 24/40; H05H 7/02; H05H 2007/025; H05H 9/00

(57) ABSTRACT

A radio-frequency (RF) generator arrangement includes a combiner that includes an RF plug socket and an RF generator including a plug that matches the RF plug socket. The RF plug socket includes an opening for receiving the plug, an external contact for connection to an earth connection, an internal contact for connection to an RF signal, and an opening-narrowing device configured to reduce the opening so that the opening assumes a reduced-opening state when the plug is removed. In the reduced-opening state, an opening distance of the opening is reduced compared to a first opening distance, and/or an opening cross section of the opening is reduced compared to a first opening cross section. The opening-narrowing device includes an electrically conductive barrier connected to the external contact and configured to prevent electromagnetic radiation of the RF signal emitted from the internal contact from exiting from the opening in the reduced-opening state.

### CROSS REFERENCE TO RELATED APPLICATIONS

This application is a continuation of International Application No. PCT/EP2023/062201 (WO 2023/217741 A1), filed on May 9, 2023, and claims benefit to German Patent Application No. DE 10 2022 111 955.6, filed on May 12, 2022. The aforementioned applications are hereby incorporated by reference herein.

### FIELD

Embodiments of the present invention relate to a radiofrequency generator arrangement comprising a combiner, wherein the combiner has one or more plug-in connection(s) for transmitting a high-power signal, in particular a microwave signal.

### BACKGROUND

Microwave signals are used for heating, plasma generation, communication technology, radar technology, particle accelerators for research or medical technology, for example. These applications generally require a microwave generator to generate a microwave signal or, in the case of other high-power signals, an appropriate generator.

A solid-state high-power generator, a so-called solid-state power generator (SSPG), can be used to generate microwaves. A microwave input signal from an SSPG can be amplified by solid-state high-power amplifiers, solid-state power amplifiers (SSPA). An SSPA is therefore part of an SSPG. Several SSPGs can be combined to generate high powers. A combiner is used for this purpose. This is a hardware component, in particular a passive hardware component, which is designed to combine several input signals to form a more powerful output signal. The SSPGs or SSPAs are connected to the combiner in order to conduct the signal from one component to the other. In such a system consisting of several SSPG modules or SSPA modules and a combiner, it may be the case that a module has to be replaced, either because of a defect or for maintenance purposes.

When replacing such a module, it is advantageous if there is a plug-in connection between the module and the combiner, with which plug-in connection the output signal of the module can be electrically connected to the combiner. When replacing the module, the plug-in connection of the module can be disconnected from that of the combiner. The module can then be removed from the system, in which the module is fixed to a housing by means of screw connection, for example. A functional module can then be used at the appropriate location. This results in a time period during which no component is connected to the corresponding plug element of the connection of the combiner by another plug element. The plug element of the combiner, which can be a socket, is open in this period of time and is exposed to the surrounding area. This allows radiation to escape from the socket and also allows substances and/or radiation from the surrounding area to enter the socket.

If the module is to be replaced during ongoing operation, the system should be configured accordingly. If the system is designed so that components, for example modules, can be connected and disconnected during ongoing operation, this is referred to as hot-plug capability. For this purpose, the plug-in connections can be designed such that, when connecting a plug-in connection that has several conductors, the conductors are not simultaneously connected to the corresponding counterpart on account of the system design. This can be done by arranging the conductors offset in the direction of movement when plugging one plug element into the other plug element. For example, such plug-in connectors may be designed such that, during plug-connection, the earth connection is established first, before the cable to the power signal is connected, or conversely, during unplugging, the cable to the power signal is disconnected first, before the cable to the ground connection is disconnected. This provides safety, for example.

It has been determined that, during operation of such a system, electromagnetic radiation may escape from a plug-in connector element, for example from a plug socket of a combiner, when this is open. Although this connection is designed as an input for receiving signals, in particular if RF signals are connected to the other inputs of the combiner, electromagnetic radiation can be emitted here. The more short-wave such radiation is, the more electromagnetic radiation can be emitted. In the microwave range, at 300 MHz or more, in particular at 1 GHz or more, the wavelength is often already so short that an open plug element can act like a dipole antenna. This negative property worsens when the dimensions of the connectors become larger, as is often necessary, for example, as a result of large cables, in order to keep the electrical losses low. The emitted electromagnetic radiation can be harmful to humans, especially at high powers, such as occur in high-power equipment. In addition, the radiation can also interfere with or damage other equipment.

### SUMMARY

Embodiments of the present invention provide a radio-frequency (RF) generator arrangement. The RF generator arrangement includes a combiner. The combiner includes an RF plug socket, and an RF generator. The RF generator includes, at a microwave (MW) output thereof, a plug that matches the RF plug socket. The RF plug socket is configured for transmitting an RF signal. The RF plug socket includes an opening with a first opening distance and a first opening cross section configured to receive the plug, an external contact configured for connection to an earth connection, an internal contact configured for connection to the RF signal, and an opening-narrowing device configured to reduce the opening so that the opening of the RF plug socket assumes a reduced-opening state when the plug is removed from the RF plug socket. In the reduced-opening state, an opening distance of the opening is reduced in relation to the first opening distance, and/or an opening cross section of the opening is reduced in relation to the first opening cross section. The opening-narrowing device includes an electrically conductive barrier connected to the external contact and configured to prevent electromagnetic radiation of the RF signal emitted from the internal contact from exiting from the opening in the reduced-opening state.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a cross-sectional view of a plug-in connection in the unplugged state according to some embodiments;

FIG. 2 shows a cross-sectional view of a further plug-in connection in the unplugged state according to some embodiments;

FIG. 3a shows a cross-sectional view of a plug-in connection as shown in FIG. 1 or 2 in the partially plugged-in state according to some embodiments;

FIG. 3b shows a cross-sectional view of a plug-in connection as shown in FIG. 1, 2 or 3a in the fully plugged-in state, according to some embodiments;

FIG. 4 shows a cross-sectional view of an alternative plug-in connection in the unplugged state, according to some embodiments;

FIG. 5 shows a cross-sectional view of a plug-in connection as shown in FIG. 4 in the partially plugged-in state, according to some embodiments;

FIG. 6 shows a front view of a plug socket in the unplugged state, according to some embodiments; and

FIG. 7 shows several RF generators and a combiner with corresponding plug-in connections according to some embodiments.

### DETAILED DESCRIPTION

Embodiments of the invention provide a radiofrequency generator arrangement comprising a combiner having an RF plug socket, in particular several RF plug sockets, for transmitting a high-power signal, in particular a microwave signal, in particular a high-power microwave signal, which radiofrequency generator arrangement overcomes the disadvantages described above.

In one aspect, the radiofrequency (RF), in particular microwave, generator arrangement comprises a combiner, wherein the combiner has:
an RF plug socket, in particular several RF plug sockets, and
an RF generator, in particular several RF generators, preferably one RF generator for each RF plug socket, wherein
each RF generator has at its MW output a plug that matches the RF plug socket, wherein
the radiofrequency (RF) plug socket is suitable for transmitting an RF signal, in particular a high-power signal, in particular a high-power microwave signal, and has:
a. an opening with a longest opening distance and an opening cross section designed to receive a matching plug,
b. an external contact suitable and in particular designed for connection to an earth connection,
c. an internal contact suitable and in particular designed for connection to an RF power signal, in particular microwave signal,
d. wherein the plug socket has an opening-narrowing device, which is designed to reduce the opening in such a way that the opening of the plug socket assumes a reduced-opening state when the plug is removed, in which state
i. a reduced longest opening distance of this opening is reduced in relation to the longest opening distance, and/or
ii. a reduced opening cross section of this opening is reduced in relation to the opening cross section,
iii. in particular the opening is closed,
e. wherein the opening-narrowing device has an electrically conductive barrier, which is connected to the external contact and is designed to prevent electromagnetic radiation of the RF signal, which electromagnetic radiation can be emitted from the internal contact, from exiting from the opening in the reduced-opening state.

Opening-narrowing device refers to a device, in particular a mechanical device, which is suitable for moving the cross section and/or the longest distance of an opening from a first state with an original opening cross section and/or an original longest opening distance to a second state with a reduced opening cross section and/or a reduced longest opening distance.

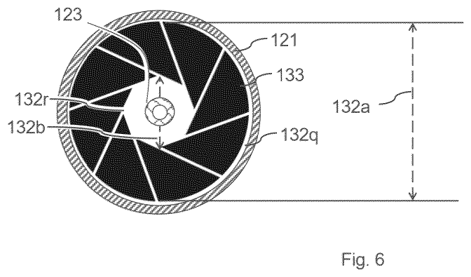

“Longest opening distance” refers to the longest distance that can or could be determined in the state with the plug plugged in. “Reduced longest opening distance” refers to the longest distance that can be determined in the state with the plug unplugged. “Opening cross section” refers to the cross section that can or could be determined in the state with the plug plugged in. “Reduced opening cross section” refers to the cross section that can be determined in the state with the plug unplugged. These terms are also illustrated further below with reference to the example in FIG. 6 and the description thereof.

It may be sufficient under certain circumstances to maintain the opening cross section and reduce only the longest opening distance. For example, when the longest opening distance is in the range of one quarter of the wavelength λ of the emitting RF signal—or a multiple of it. In such a case, for example, a slot-like opening of this length can provide considerable radiation. If this longest opening distance is reduced, the radiation can be significantly reduced, even if the opening cross section remains the same or even becomes slightly larger at the same time.

RF signal refers to signals of 1 MHz or more. The RF plug socket can be designed, in particular, for frequencies from 100 MHz. Microwave signal refers to signals of 300 MHz or more, in particular 1 GHz or more. High-power signal refers to signals at 1 kW or more, in particular at 5 kW or more.

In one aspect, the RF plug socket is characterized in that the internal contact and the external contact are configured in such a way that, when the plug is pulled out or plugged in, there is a position in which an electrical connection to the internal contact by way of the corresponding contact of the plug is disconnected, and at the same time there is an electrical connection to the external contact by way of the corresponding contact of the plug.

In one aspect, the internal contact is set back in relation to the external contact. This is to be understood to mean that the internal contact is shorter than the external contact, so that the electrical fields are clearly kept in the plug socket and preferably propagate there. The opening-narrowing device then additionally prevents the electrical fields from escaping from the plug socket.

In one aspect, the RF plug socket is configured in such a way that the barrier is in electrical contact with the internal contact in the reduced-opening state. This allows any electrical signals at this contact to be short-circuited to earth. In the arrangement of the plug socket on a combiner, which will be described below, the distance to the neutral point of the combiner can then be set as a function of the wavelength λ of the RF signal such that the combiner recognizes this branch as neutral at the neutral point.

In one aspect, the RF plug socket is configured in such a way that the barrier is not in electrical contact with the internal contact in the reduced-opening state. This is an alternative to the above aspect and can have advantages given certain configurations of the combiner.

In one aspect, the RF plug socket is characterized in that the barrier has regions containing a material that absorbs the electromagnetic radiation. This material may be designed to preferably absorb the electromagnetic waves and not reflect them and may be matched to the wave impedance of air and in particular have an impedance of about 300Ω to 400Ω.

In one aspect, the RF plug socket is characterized in that the barrier is configured to prevent the electromagnetic radiation irradiated via the opening in the reduced-opening state. It thus fulfils another advantageous purpose and supports the reliability of the system.

In one aspect, the RF plug socket is characterized in that the opening-narrowing device has an elastically deformable, in particular resilient, component for narrowing the longest opening distance. This can also be, for example, a steel spring, in particular a spiral spring arrangement. This allows the opening-narrowing device to automatically move to the reduced-opening state when the plug is removed.

In one aspect, the RF plug socket is characterized in that the barrier has a flap, which is in particular configured to be held in the reduced-opening state by way of an elastically deformable, in particular resilient, component. This makes handling easier.

In one aspect, the RF plug socket is characterized in that the internal contact is constructed from an erosion-resistant material. This is advantageous when the plug-in connectors are open, while a current is flowing and inductive components are connected to the plug or the plug socket. Opening the contact then actually often leads to flashovers, which can contaminate the contacts. This can lead to undesired contact problems. If the internal contact is constructed from an erosion-resistant material, such contaminants can be reduced.

In one aspect, the RF plug socket is characterized in that it has precisely one inner conductor and in particular also precisely one outer conductor and in that it is, in particular, a coaxial plug-in connection. In such refinements of the plug socket, such an opening-narrowing device can preferably be used for reducing radiation.

In one aspect, the RF plug socket is designed to be mounted on a housing wall, in particular on a combiner housing wall. This makes handling easier.

In one aspect, a plug-in connection having the RF plug socket and a plug is provided, which plug is matched by way of its contacts to the contacts of the RF plug socket.

In one aspect, the plug-in connection is characterized in that the RF plug socket and the plug can be disconnected and/or connected during ongoing operation, without operation of the connected components being adversely affected, in particular in that the plug-in connection has hot-plug capability.

As mentioned above, a combiner having one, in particular several, of the above-described RF plug sockets is provided. Combiner refers to an RF power combiner, in particular microwave power combiner, which is designed to combine several input power signals to form an output power signal.

The combiner can in particular also be designed for an RF signal with a frequency of 1 MHz or more, in particular designed for a frequency from 100 MHz, preferably for a frequency in the microwave range of 300 MHz or more, in particular 1 GHz or more. The combiner can in particular also be designed for high-power signals at its inputs at 1 kW or more, in particular at 5 KW or more.

The combiner can be configured such that several RF generators, each having an above-described plug matched to the RF plug sockets, are arranged next to each other, in particular arranged directly next to each other, on the combiner, and can be plugged in and unplugged during operation, in particular in a preferred direction. Owing to the narrowing of the opening, the RF plug sockets can be arranged relatively close to each other here, this being advantageous for the now quite small RF generators if they are to be placed closely next to each other. Plugging in and unplugging during operation works well, of course, if the connections for an input signal and the power supply to the RF generators are also arranged on the same front side as the plugs for connection to the combiner. The above-described plug sockets on the combiner are advantageous since the interference that emerges from the combiner when the RF generator is unplugged does not feed back to the input signal and the power supply.

Each RF generator can have one or more amplifier modules.

The amplifier modules can each have a water cooling means.

The amplifier modules can each have a circulator.

Several amplifier modules in an RF generator can combine their respectively outputtable power via special combiners, in particular a 90° hybrid coupler, in order to be able to feed this power to the output of the RF generator.

The RF, in particular microwave, generator arrangement can be designed for operation on a particle accelerator (linear particle accelerator). In this case, RF generators that can be replaced during operation are advantageous since such particle accelerators can be started only with great effort.

In the following, preferred embodiments of the invention are described in association with the drawings. Individual features of these exemplary embodiments can also develop the above-described methods or devices separately from other features of the respective exemplary embodiments.

Elements that are the same or have equivalent functions are denoted by the same reference signs in all the exemplary embodiments.

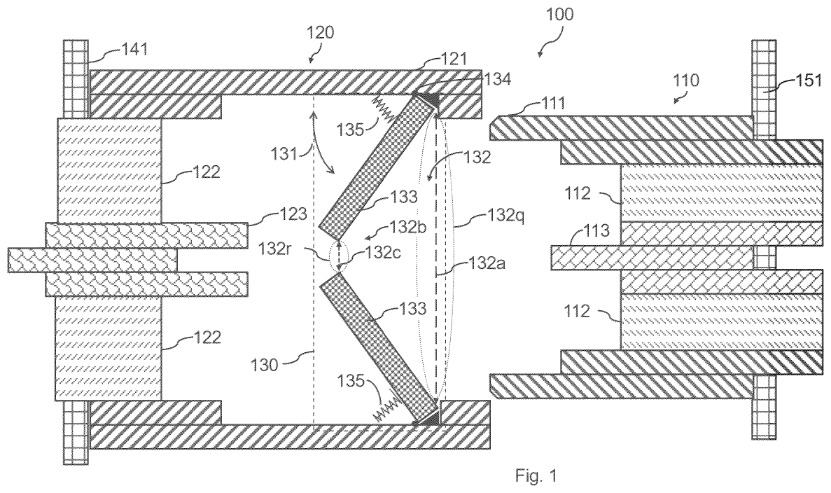

FIG. 1 shows a cross-sectional view of one embodiment of a plug-in connection 100. This plug-in connection has a first plug element in the form of a plug 110. The figure furthermore shows a second plug element in the form of a plug socket 120 which is matched to the first plug element in the form of a plug 110.

The plug socket 120 is designed as a radiofrequency (RF) plug socket and is suitable for transmitting a signal, in particular a high-power signal, in particular a high-power microwave signal. The plug socket 120 is designed here as a coaxial plug socket with precisely one inner conductor 123 and precisely one outer conductor 121, which is of tubular configuration.

The outer conductor 121 can be electrically connectable, in particular connected, to earth. This outer conductor can be electrically and mechanically connected to a housing wall 141 of the combiner 400.

The inner conductor of the plug socket 123 can be electrically connected to the RF signal, in particular the high-power signal, in particular the high-power microwave signal. This inner conductor 123 can have an electrical connection to the interior of the combiner 400 for transmitting the RF signal, in particular a high-power signal, in particular a high-power microwave signal.

The inner conductor 123 and the outer conductor 121 are electrically isolated by an insulator 122. The outside diameter of the inner conductor 123, the inside diameter of the outer conductor 121 and the electrical properties of the insulator can be designed such that the plug socket 120 has a predefined wave impedance, for example of 50Ω. This can be designed in particular such that there is a reduction in electrical reflections of the incoming and outgoing electromagnetic waves at the plug socket 120.

The plug socket 120 has an opening 132 into which the plug 110 can be inserted in a matching manner. The opening 132 has a longest opening distance 132a, which is indicated as a dashed line with a double-headed arrow in FIG. 1. The opening 132 has an opening cross section 132q, which is indicated as a dotted oval-shaped line in FIG. 1.

Here, the plug 110 also has an outer conductor 111 and an inner conductor 113 and also an insulation, which electrically isolates the outer conductor 111 from the inner conductor 113. As shown in FIG. 1, the plug 110 can be fitted to a housing wall of an RF generator, for example an SSPG, so that RF signals from the SSPG can be passed to the inner conductor.

The plug socket 120 has an opening-narrowing device 130. The opening-narrowing device 130 has a barrier 133, which is movably mounted in a joint 134 here. Other fastening devices that allow movement are also conceivable. Here, the barrier 133 is designed so as to be moved by one or more spring element(s) 135 to a position in which the opening cross section 132a of the plug socket is reduced to a reduced opening cross section 132c when the plug 110 is not inserted into the socket. The direction of movement of the barrier 133 is shown by the arrow 131 here. In FIG. 1, the plug 110 is not inserted and, as a result, the plug socket 120 is in a reduced-opening state 132b, in which the reduced cross section 132r of the opening 132 is reduced in relation to the opening cross section 132q and the reduced longest opening distance 132c of this opening 132 is reduced in relation to the longest opening distance 132a.

In this case, the barrier 133 is, in particular, electrically conductive and connected to the external contact 121 and designed to prevent electromagnetic radiation of the RF signal, which electromagnetic radiation can be emitted from the internal contact 123, from exiting from the opening in the reduced-opening state.

Slight narrowing of the opening cross section, as may already be known from the prior art for example by locking devices, contact springs or other elastic contact devices in the interior of the outer conductor of a plug, is expressly not meant. Clearly deliberate narrowing, which is designed and set up to prevent electromagnetic radiation, is meant here. For this purpose, for example, the longest opening distance in the reduced-opening state 132b can be designed to be smaller than λ/10, where λ is the wavelength of the RF signal. The ‘longest opening distance’ refers, for example, to the diameter in the case of a round opening. However, other openings are also conceivable, e.g. an oval, an angular or slot-like opening. A further conceivable opening-narrowing device 130 would be an aperture, as is known from cameras and as is illustrated in FIG. 6 by way of example. In the case of all of these openings, the longest opening distance can be geometrically determined both in the reduced-opening state 132b and in the fully open state.

The opening-narrowing device 130 can automatically adjust to the reduced-opening state 132b when the plug 110 is pulled out. No additional grips are then required.

Mechanical auxiliary means can be provided, so that the opening-narrowing device 130 is adjusted from the reduced-opening state 132b fully to the open state by inserting the plug. The plug can thus be inserted without additional grips.

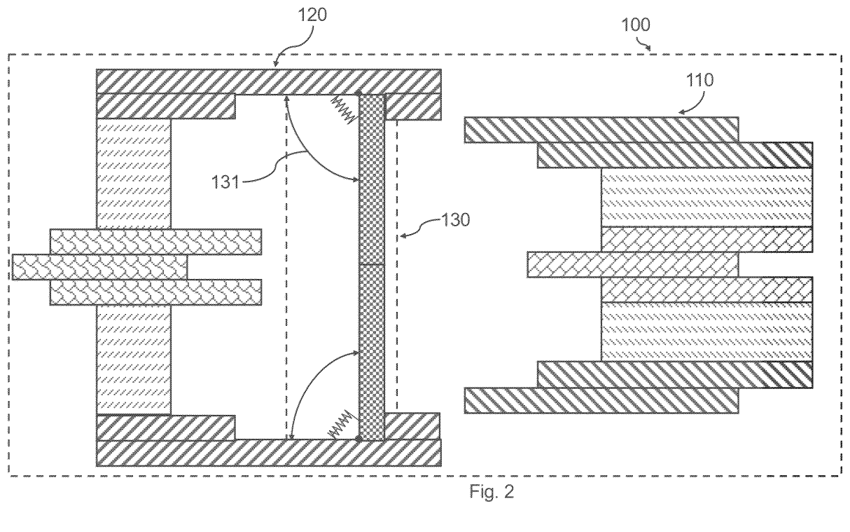

FIG. 2 shows a further embodiment of the plug-in connection 100. The plug 110 is not inserted and consequently the plug socket 120 is in a reduced-opening state 132b in FIG. 2 too. In this case, the opening-narrowing device 130 is designed such that the opening 132 is completely closed in this state.

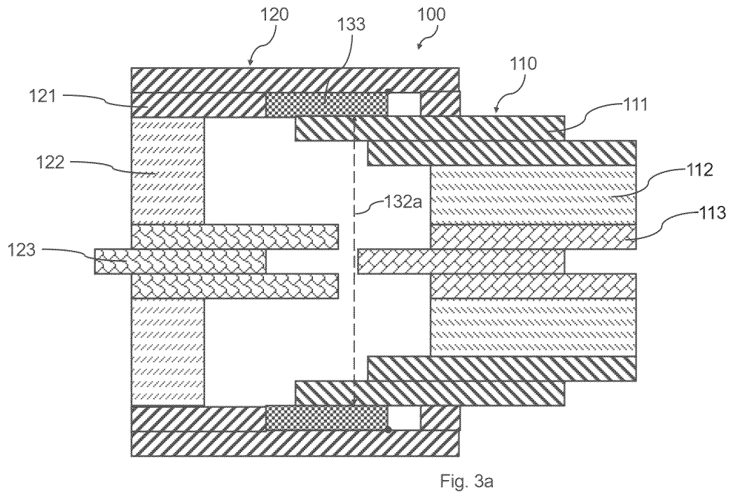

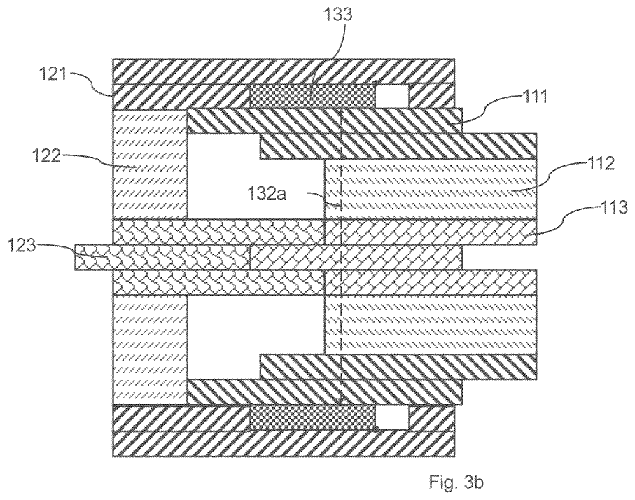

FIG. 3a shows a cross-sectional view of a plug-in connection as shown in FIG. 1 or 2, in which the plug 110 is partially, but not yet completely, inserted into the plug socket 120. The opening-narrowing device 130 is automatically moved to the open state by the plug. For this purpose, the barrier 133 was moved to the open state by the first plug element 110 being axially pushed into the second plug element 120. The barrier 133, which can be electrically conductive, electrically connects the outer conductor 121 of the plug socket 120 to the outer conductor 111 of the plug 110. However, there is still no contact between the inner conductor 123 of the plug socket 120 and the inner conductor 113 of the plug 110 here. This has the advantage that the two devices connected to the plug-in connectors, that is to say, for example, combiner on the plug socket 120 and generator on the plug 110, can be brought to a common potential, for example a common earth potential, before the RF signals are electrically connected to each other. This is advantageous in systems with hot-plug capability.

FIG. 3b shows a cross-sectional view of a plug-in connection as shown in FIG. 1, 2 or 3a, wherein the plug 110 is now completely plugged into the plug socket 120. In contrast to FIG. 3a, the two internal contacts, the inner conductor 123 of the plug socket 120 and the inner conductor 113 of the plug 110 are now electrically connected to each other, so that an RF signal can flow from a generator to the combiner. The opening-narrowing device 130 is completely open here. In addition, it ensures good electrical contacting of the outer conductors 121, 111 of the plug-in connection 100 owing to the elastic configuration or spring contacts.

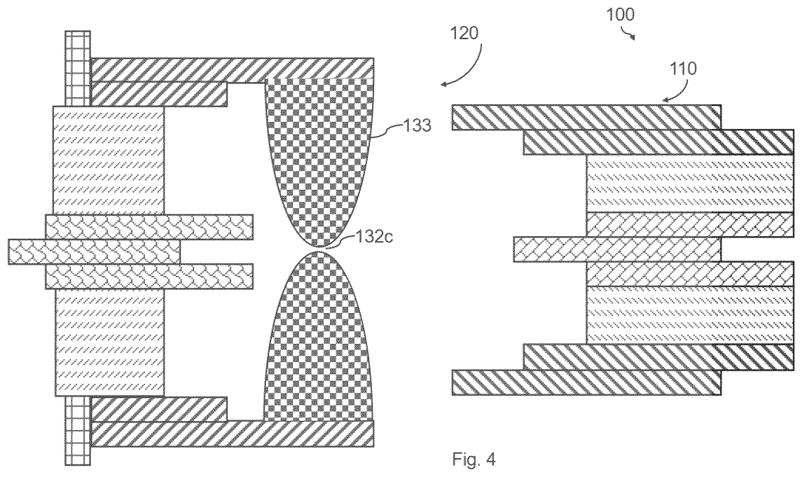

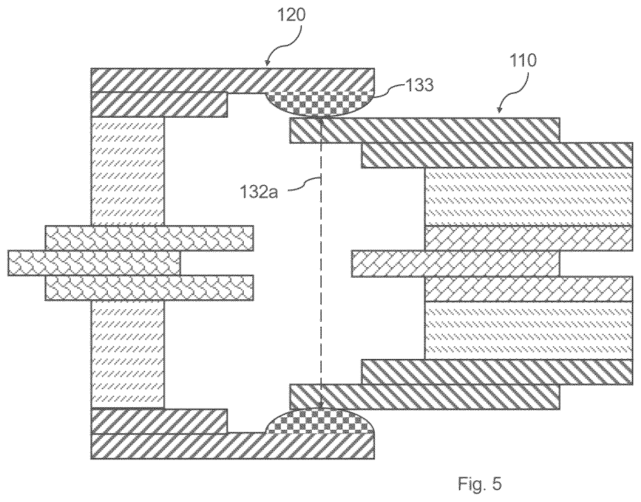

FIG. 4 shows a further embodiment of the plug-in connection. In this case, the opening-narrowing device is configured in the form of an elastic component by the barrier 133. This component is able to compress radially under axial force by selecting the geometric shape. The opening is thus cleared under axial force for plugging in another plug element, and in the state in which no plug-in connection is established, the opening is narrowed or closed by the opening-narrowing device, which consists exclusively of the barrier 133. In the plugged-in state, as shown in FIG. 5, the barrier 133 is situated outside the area that the first plug element 110 needs in order to move into the second plug element 120 for connection.

FIG. 6 shows a front view of a plug socket in the unplugged state. The barrier is configured in the form of an aperture, as is known from cameras. FIG. 6 illustrates that both the reduced longest opening distance 132c and the longest opening distance 132a can be geometrically determined, as can both the reduced opening cross section 132r and the opening cross section 132q.

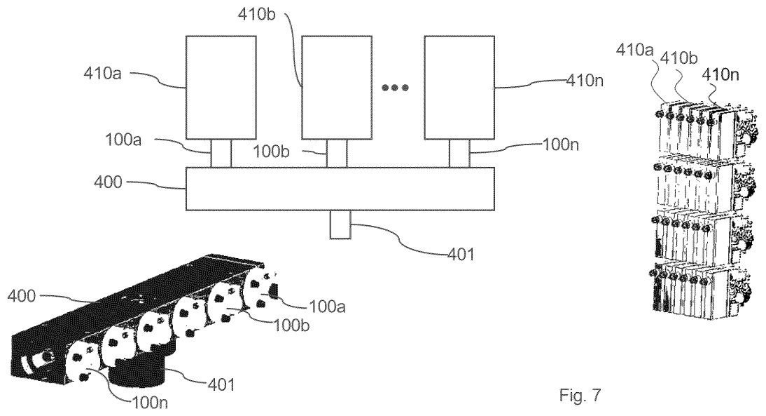

FIG. 7 schematically shows a perspective view, together and in each case individually, of several RF generators 410a, 410b . . . 410n, each having an amplifier module, and a combiner 400 with corresponding plug-in connections 100a, 100b, . . . 100n. The generators 410a, 410b . . . 410n are preferably each structurally identical. The generators 410a, 410b . . . 410n can be plugged in and unplugged in particular individually under voltage and current. The generators 410a, 410b . . . 410n are preferably configured as solid-state high-power microwave generators (solid-state power generators, SSPG) here.

In this case, the RF generators 410a, 410b . . . 410n can be arranged closely, in particular directly, next to each other, with their output each directly connected to the combiner via the above-described plug-in connections 100a, 100b, . . . 100n with hot-plug capability, without interconnection of diverter arrangements.

A similar arrangement having several RF generators (PAU) and a combiner (SCU) is disclosed, for example, in U.S. Pat. No. 9,492,567 B1 “Combined RF/microwave amplifiers with individual power supplies”. As can be gathered from the description, and in particular from FIG. 3 described therein, the plug-in connections (connector 3021) do not have an opening-narrowing device, as is described here. FIG. 6 shows a combiner (SCU) and the combiner is described in the description of this figure. There is no opening-narrowing device provided on the high-power plug-in connections 601-610 here either. Under certain circumstances, due to the increased radiation when exchanging an RF generator during operation, the high-power plug-in connections 601-610 in FIG. 6 had to be arranged spaced further apart from each other than the dimensions of the combiner housing have permitted. This could be the reason for the arm-like, star-shapedly protruding outriggers for the plug-in connectors in FIG. 6. This arrangement obviously leads to an increased expenditure on manufacture. With such a star-shaped arrangement, it is also not possible to arrange a large number of RF generators (PAU) closely next to each other and to connect them, with their output, in each case directly to the combiner via the plug-in connections, without the interconnection of deflection arrangements. These deflection arrangements also undoubtedly lead to further increased manufacturing costs. These could also be overcome with embodiments of the present invention.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A radio-frequency (RF) generator arrangement comprising a combiner, wherein the combiner comprises:
an RF plug socket, and
an RF generator, wherein
the RF generator comprises, at a microwave (MW) output thereof, a plug that matches the RF plug socket, wherein
the RF plug socket is configured for transmitting an RF signal, and comprises:
an opening with a first opening distance and a first opening cross section configured to receive the plug,
an external contact configured for connection to an earth connection,
an internal contact configured for connection to the RF signal, and
an opening-narrowing device configured to reduce the opening so that the opening of the RF plug socket assumes a reduced-opening state when the plug is removed from the RF plug socket, wherein, in the reduced-opening state
an opening distance of the opening is reduced in relation to the first opening distance, and/or
an opening cross section of the opening is reduced in relation to the first opening cross section,
wherein the opening-narrowing device comprises an electrically conductive barrier connected to the external contact and configured to prevent electromagnetic radiation of the RF signal emitted from the internal contact from exiting from the opening in the reduced-opening state.

2. The RF generator arrangement according to claim 1, wherein the internal contact and the external contact of the RF plug socket are configured in such a way that, when the plug is pulled out or plugged in, there is a position in which an electrical connection to the internal contact by a first corresponding contact of the plug is disconnected, and at a same time there is an electrical connection to the external contact by a second corresponding contact of the plug.

3. The RF generator arrangement according to claim 1, wherein the opening-narrowing device of the RF plug socket comprises an elastically deformable component for reducing the opening distance.

4. The RF generator arrangement according to claim 1, wherein the electrically conductive barrier of the opening-narrowing device comprises a flap configured to be held in the reduced-opening state via an elastically deformable component.

5. The RF generator arrangement according to claim 1, wherein the internal contact of the RF plug socket is constructed from an erosion-resistant material.

6. The RF generator arrangement according to claim 1, wherein the RF plug socket is mounted on a housing wall.

7. (canceled)

8. The RF generator arrangement according to claim 1, wherein the RF plug socket and the plug are capable of being disconnected and/or connected during ongoing operation, without operation of connected components being adversely affected.

9. The RF generator arrangement according to claim 1, wherein the combiner is configured to combine several input power signals to form an output power signal with a frequency of 1 MHZ or more.

10. The RF generator arrangement according to claim 1, wherein the combiner is configured for high-power signals at inputs thereof at 1 kW or more.

11. The RF generator arrangement according to claim 1, wherein the combiner is configured for several RF generators, each RF generator having the plug matched to the RF plug sockets, to be able to be arranged next to each other on the combiner, and to be able to be plugged in and unplugged during operation.

12. The RF generator arrangement according to claim 11, wherein each RF generator comprises one or more amplifier modules.

13. The RF generator arrangement according to claim 12, wherein each amplifier module comprises a circulator.

14. The RF generator arrangement according to claim 12, wherein each amplifier module comprises a respective water cooling system.

15. The RF generator arrangement according to claim 12, wherein the RF generator arrangement is configured for operation on a particle accelerator.
